(19) United States
(12) Patent Application Publication
(10) Pub. No.: US 2016/0195137 A1
(43) Pub. Date: Jul. 7, 2016

(54) ABRADABLE SEAL AND SEALING ARRANGEMENT

(71) Applicant: Siemens Aktiengesellschaft, München (DE)

(72) Inventors: Christoph Grund, Gorlitz (DE); Bernd Leidinger, Dresden (DE)

(73) Assignee: Siemens Aktiengesellschaft, Munich (DE)

(21) Appl. No.: 14/905,029

(22) PCT Filed: Aug. 6, 2014
(86) PCT No.: PCT/EP2014/066893

§ 371 Date: Jan. 14, 2016

(30) Foreign Application Priority Data
Sep. 30, 2013 (DE) 10 2013 219 766.7

(51) Int. Cl. F16C 33/72; F16J 15/447; F16C 32/04; F16J 15/16

(52) U.S. Cl. CPC F16C 33/72; F16J 15/16; F16J 15/447; F16C 32/047; F16C 32/0442

(57) ABSTRACT

An abradable seal, in particular for rotors that are mounted on magnetic bearings, has a sealing shell, the sealing shell having an oval opening for accommodating the rotor. A sealing arrangement includes such an abradable seal.

### CROSS REFERENCE TO RELATED APPLICATIONS

This application is the US National Stage of International Application No. PCT/EP2014/066893 filed Aug. 6, 2014, and claims the benefit thereof. The International Application claims the benefit of German Application No. DE 102013219766.7 filed Sep. 30, 2013. All of the applications are incorporated by reference herein in their entirety.

### FIELD OF INVENTION

The invention relates to an abradable seal and also to a sealing arrangement.

### BACKGROUND OF INVENTION

In order to increase the efficiency of turbomachines, the radial gap between rotating and stationary components has to be kept as small as possible in order to thereby minimize flow losses within the turbomachine. What are termed abradable seals are often used to seal off the radial gap. The abradable seals have a removable run-in layer on the inner side thereof. The run-in layer allows for the rotor or the tips of the turbine blades to rub and run in on the sealing strip of the abradable seal without damage thereby occurring on the rotating component.

The honeycomb seal, which has been known for a long time as conventional run-in layers, has a honeycomb-shaped structure, which, upon rubbing, partly yields and partly can be removed, giving rise to minimal play between the rotating component and the stationary component.

New types of run-in layers are formed from porous material in the form of foamed, metallic alloys. An abradable seal of this type is disclosed, for example, in EP 1 013 890 A2.

When choosing the abradable seal, attention should be paid primarily, in addition to the selection of a suitable run-in layer, to the correct internal diameter of the abradable seal. The internal diameter arises in this case firstly from the diameter of the rotating component and secondly from the radial deflection of the rotating component from the axial central position thereof. If the diameter is chosen to be too small, this may lead to excessive rubbing of the rotor or of the blade tips of the turbomachines on the abradable seal in the case of relatively large radial deflections during the operation of the turbomachine, and this would result in destruction of the abradable seal. The greater the expected radial deflections, the larger the internal diameter and therefore the radial gap between the rotating component and the stationary component have to be chosen.

In the case of rotors mounted on electromagnetic bearings, very large radial deflections occur as a result of the design. In the electroless state, the rotor is usually located in what are termed touchdown bearings, these also retaining the rotor in the event of shedding of the rotor. In the energized state, the rotor is raised substantially vertically by the magnetic bearing and held in this position. The vertical deflection has to be taken into consideration when choosing the internal diameter of the seal. The large vertical displacement gives rise to large internal diameters, and as a result thereof large radial gaps, these leading to high losses in efficiency.

### SUMMARY OF INVENTION

Proceeding from the problem described above, it is an object of the present invention to provide an abradable seal which makes it possible to achieve an improved efficiency during use in turbomachines. Furthermore, it is an object of the invention to provide a sealing arrangement having such an abradable seal.

With respect to the abradable seal, and with respect to the sealing arrangement the object is achieved by the features of the independent patent claims.

Further embodiments of the invention, which can be used individually or in combination with one another, are the subject matter of the dependent claims.

The abradable seal according to the invention, in particular for rotors mounted on magnetic bearings, comprising a sealing shell, is distinguished by the fact that the sealing shell has an oval opening for receiving the rotor.

By virtue of the oval opening of the sealing shell, the radial gap between a rotor and a stationary housing can be minimized particularly when the rotor is deflected substantially in one direction, as is the case for example in rotors mounted on magnetic bearings. The abradable seal can then be oriented in such a manner that the longitudinal extent thereof corresponds substantially to the direction of the main deflection of the rotor. The radial gap can thereby be minimized transversely in relation to the main deflection. The oval design of the opening thus allows for a large deflection of the rotor in the longitudinal direction, and at the same time ensures that there is a small radial gap in the transverse direction.

On account of its run-in layer, the sealing shell of the abradable seal here allows for slight rubbing and running-in of the rotor or of the turbine blade in the sealing shell, as a result of which a further reduced radial gap is achieved.

One embodiment of the invention provides that the sealing shell has a split form. The split design of the sealing shell allows for easier assembly of the abradable seal.

A further advantageous embodiment of the invention provides that the abradable seal is in the form of a labyrinth abradable seal. The labyrinth seal has a plurality of circumferential sealing strips, which are arranged transversely to the direction of flow and spaced apart from one another and which make it possible to achieve an improved sealing action of the abradable seal.

The sealing arrangement according to the invention, comprising at least one abradable seal as claimed in one of claims 1 to 3, for sealing off a gap between the rotor and a housing, wherein the rotor is supported by active magnetic bearings, and provision is made of touchdown bearings, which perform the mounting of the rotor in the event of failure or during downtime of the rotor, is distinguished by the fact that the abradable seal is arranged in such a manner that the longitudinal axis L thereof is oriented in a substantially vertical manner. The vertical orientation of the longitudinal axis of the abradable seal ensures that there is no excessive contact between the rotor or the blade tips and the sealing shell of the abradable seal, which would result in damage to the sealing shell, as the rotor is being raised or as the rotor is being lowered into the touchdown bearings. At the same time, the oval shape of the sealing shell achieves a very narrow sealing gap in the transverse direction, giving rise to optimum sealing of the sealing gap and therefore an increase in the efficiency of the abradable seal.

The oval design of the sealing shell thus achieves an improvement in the efficiency of the abradable seal particularly in rotors which have a high deflection in a main direction, as is the case for example in rotors mounted on magnetic bearings.

### BRIEF DESCRIPTION OF THE DRAWINGS

FIG. 1 shows an exemplary embodiment of a sealing arrangement of the invention.

### DETAILED DESCRIPTION OF INVENTION

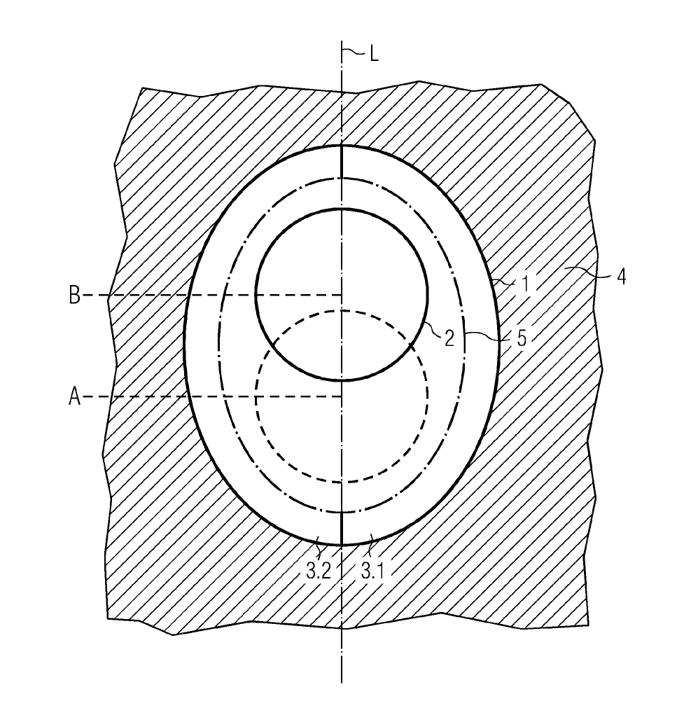

FIG. 1 shows a sealing arrangement according to the invention having the abradable seal according to the invention, in a radial section. The FIGURE shows only a schematic, greatly simplified illustration of the sealing arrangement in which only the components essential to the invention are shown.

FIG. 1 shows a sealing arrangement, the sealing arrangement comprising at least one abradable seal 1 arranged in a housing 4. The abradable seal 1 serves to seal off a radial gap between the rotor 2 and the housing 4. The sealing shell 3 has a split form in the vertical direction (3.1; 3.2). The inner side of the sealing shell 3 has a run-in coating 5, on which the rotor can rub or run in. The rotor 2 is supported by active magnetic bearings (not shown), and provision is made of touchdown bearings, which perform the mounting of the rotor 2 in the event of shedding or during downtime of the rotor 2. In the electroless state, the rotor 2 is in its lower end position A. In this lower end position A, the rotor 2 can come into contact with the run-in coating 5, the bearing being oriented in such a way that only slight rubbing on the run-in coating 5 is provided, so that the run-in coating 5 is not destroyed by the lowering of the rotor 2. During operation, the rotor 2 is raised into an upper end position B by the active magnetic bearings. The abradable seal 1 is formed and arranged in such a manner that it allows for maximum displacement of the rotor 2 in the axial direction from the lower end position A into the upper end position B without excessive rubbing of the rotor 2 on the abradable seal 1, which would result in destruction of the abradable seal 1. For this purpose, the abradable seal 1 is arranged in such a manner that the longitudinal axis L thereof is oriented in a substantially vertical manner, since the rotor 2 is deflected in a substantially vertical manner in the event of failure during raising and during shedding of the rotor 2. By virtue of the oval design of the abradable seal 1, a narrow radial gap can be achieved in this case at the same time in the transverse direction, leading as a whole to an optimized sealing gap and therefore to an increased efficiency.

For assembly reasons, it is expedient in this respect that firstly a vertical sealing shell 3.1 is inserted horizontally into the housing 4, then the rotor 2 is placed in the sealing shell 3.1, the second sealing shell 3.2 is positioned and subsequently the vertical sealing shells 3.1; 3.2 are rotated through 90 degrees.

The abradable seal according to the invention and the sealing arrangement according to the invention are not only suitable for sealing off the sealing gap between a rotor and a housing, as described in the exemplary embodiment, but also for sealing off a gap between the tips of turbine blades and the housing. The abradable seal according to the invention and the sealing arrangement according to the invention can be used wherever there is a relatively large displacement of the rotor in a main direction, while the displacement in the other directions is small. By virtue of the oval design of the abradable seal, in this case the radial gap between the rotating component and the housing can be minimized and therefore the efficiency can be optimized.

1. An abradable seal mounted on magnetic bearings, comprising
a sealing shell,
wherein the sealing shell has an oval opening for receiving the rotor.

2. The abradable seal as claimed in claim 1,
wherein the sealing shell has a split form.

3. The abradable seal as claimed in claim 1,
wherein the abradable seal is in the form of a labyrinth abradable seal.

4. A sealing arrangement, comprising
at least one abradable seal as claimed in claim 1, adapted for sealing off a gap between a rotor and a housing, wherein the rotor is supported by active magnetic bearings, and
touchdown bearings, which perform the mounting of the rotor in the event of failure or during downtime of the rotor,
wherein the abradable seal is arranged such that the longitudinal axis (L) thereof is oriented in a substantially vertical manner.

5. The abradable seal as claimed in claim 1,
wherein the abradable seal is adapted for rotors.
